(19) United States
(12) Patent Application Publication
(10) Pub. No.: US 2011/0284432 A1
(43) Pub. Date: Nov. 24, 2011

(54) DEVICE AND METHOD FOR REMOVING IMPURITIES FROM AN AGRICULTURAL FIBROUS MATERIAL

(76) Inventor: Matthieu Johannes Jozef Van den Hurk, Groningen (NL)

(21) Appl. No.: 13/128,279

(22) PCT Filed: Nov. 11, 2008
(86) PCT No.: PCT/EP2008/009620

§ 371 Date: Aug. 2, 2011

(51) Int. Cl. D01G 9/16; B07C 5/00; D01G 9/00

(52) U.S. Cl. 209/643; 209/509; 209/644; 209/606

(57) ABSTRACT

The present invention is related to a device for removing impurities from an agricultural fibrous material. In addition, the invention is related to a method for obtaining the same. The device according to the invention comprises: a processing unit (4) having an inlet (16), an outlet (38), and a first (18) and second holding member (19) defining a holding space there between for holding said material, wherein at least said first holding member is moveable; a drive unit for driving at least said first moveable holding member to obtain a compression and expansion of said holding space; an impurities collection unit (5) coupled to or disposed in said processing unit to collect impurities released from said material; The compression and expansion of the holding space ensures an effective release of impurities from the fibers of the material.

The present invention is related to a device for removing impurities from an agricultural fibrous material.

In addition, the invention is related to a method for obtaining the same.

Agricultural fibrous material, such as hay or straw, has many applications. For instance, it can be used as food for cattle or horses or it can be applied as bedding material in stables. It should be noted that the term agricultural fibrous material will be abbreviated as material for the remainder of this application.

The nature of this material and the way that it is stored introduces health hazards to both animal and human.

Typically, straw and hay are densely packed in bales. Animate impurities such as bacteria and fungi that are present in the bale will feed on the material and grow under the influence of factors such as humidity and temperature. Other animate impurities could include yeasts, viruses and mites. In addition, toxic inanimate impurities could be present in the material as well.

Generally, the animate and inanimate impurities, which will be referred to as impurities in this application, are attached to the fibers of the material or could be captured in the space between the fibers. The inanimate impurities, and sometimes even the animate impurities that are carried with them, are also known as dust. When the material is used, e.g. it is spread onto the floor of a stable to form a stable bedding, the impurities may become airborne. Animals in the stable are likely to inhale these impurities which may lead to various respiratory problems. In addition, when the material is used as food, the impurities may also enter the digestive system of the animal.

An objective of the present invention is to provide a device and method with which these impurities can be removed from the material prior to use.

This objective is achieved with a device as defined in claim 1.

According to the invention, the device comprises a processing unit provided with an inlet, an outlet, and a first and second holding member defining a holding space there between for holding the material. At least the first holding member is moveable, although more holding members could be moveable as well. A drive unit is used for driving at least the first moveable holding member to obtain a compression and expansion of the holding space. Because of this compression and expansion, which is preferably repeated, the fibers of the material will deform either elastically or inelastically. Inelastic deformation could include the breaking or snapping of fibers. As such, the impurities which adhere to the fibers will be released during the compression and expansion. An impurities collection unit coupled to or disposed in the processing unit is provided to collect these impurities.

It is advantageous if the fibers mainly deform elastically as a result of the compression and expansion.

Inelastic deformation causes valuable nutrients, such as seeds, to detach from the fibers. In addition, the breaking of fibers would result in additional impurities. By controlling the movement type and intensity of the holding member(s), elastic deformation of the fibers can be made the dominant deformation mechanism.

It is an important aspect of the invention that the fibers are subjected to the compression and expansion induced by the holding members. There are many ways with which this can be obtained. However, the general concept is that the holding space occupied by the material between the holding members is reduced and subsequently restored or increased.

Preferably, the device comprises a filling unit arranged for filling the processing unit with the material through the inlet to obtain a filling of the material. The filling unit is capable to obtain a filling of the material extending from the first holding member to the second holding member. Although impurities can be removed if the filling does not extend fully between the first and second holding member, it has been found that the effect of the compression and expansion is much stronger if it does. Not wishing to be bound by theory, it is believed that the deformation of the fibers, and especially the elastic deformation, is responsible for the effective removal of the impurities. This is in addition to the removal of impurities when fibers rub against each other. The latter effect is more likely to be dominant when the filling does not extend fully between the holding members.

It is advantageous if the device comprises a transport unit for obtaining a stream of the material from the inlet to the outlet of the processing unit. The material can then be fed to the processing unit at the inlet, where it will be engaged by the transport unit. The transport unit will then transport the material through the processing unit, where the material will be subjected to the relative movement of the holding members. Material will exit the processing unit at the outlet.

To achieve the desired filling level, a controller can be provided for controlling the transport unit and the filling unit. By adjusting the filling rate and transport speed, the filling level can be set. A higher transport speed will usually reduce the filling level.

To achieve a high throughput, the transport unit and filling unit can be arranged to generate a continuous stream of the material.

The filling unit is preferably provided with an inlet and an outlet. It is convenient if the inlet is adapted to receive a bale of the material and if the outlet is coupled to the inlet of the processing unit. Most of the material is available in form of bales. Prior to insertion into the filling unit, the cover material for the bale must be removed. A separate unit for obtaining this could be placed in series with the filling unit.

The filling unit could comprise means to loosen the material. Especially in the case where material is fed into the filling unit in the form of a bale, the material needs to be loosened such that it can be processed by the processing unit. During the loosening of the material, impurities may be released from the material. It is therefore convenient if the filling unit, and more specifically the loosening means, is placed in a closed environment to avoid air pollution. Additionally or alternatively, it is possible to couple the impurities collection unit to the filling unit. In a preferred embodiment the loosening means comprise a first comb unit. This unit comprises a release plate provided with an opening, a toothed structure adapted to protrude and retract through this opening, and a mechanical drive for driving at least one of the toothed structure and release plate to obtain a protrusion and retraction movement of the toothed structure through the opening. In a protruded position, the toothed structure is arranged to engage the material and in a retracted position, the release plate is adapted to release the material from the retracted toothed structure. Hence, the toothed structure engages the material when it extends through the opening. When it retracts below the release plate, the material will be released from the toothed structure by the release plate. In the latter position, the release plate is in between the material and the toothed structure.

It is possible to drive the toothed structure, while keeping the release plate stationary, e.g. mounted to a mounting frame. However, the reverse and even simultaneous movement is also possible.

Preferably, the toothed structure is arranged on a tooth plate, and the mechanical drive is arranged to drive this plate. As a result, the filling unit comprises two plates, i.e. the tooth plate and release plate, which in use are subjected to a relative motion.

In a preferred embodiment, the toothed structure and mechanical drive are arranged to transport the material parallel to the release plate. As such, the filling unit also acts as a transport unit. The transport function can be realized by inducing a movement to the toothed structure for instance towards the inlet of the processing unit during the period that the toothed structure engages the material.

The combined function of the filling unit can for instance be obtained if the opening in the release plate is elongated along a first direction, and when during use the mechanical drive induces a turning motion to the toothed structure with a turning axis perpendicular to the first direction. During the protruded part of the movement of the toothed structure, the material will be moved towards the inlet. When the material is released, there is no or little movement of the material. Other types of movement, wherein the toothed structure moves towards the inlet when it engages the material, are also possible.

Preferably, the filling unit comprises a second comb unit. In this case, the first comb unit could be arranged and positioned to loosen the material and to transport the material towards the inlet of the processing unit. The second comb unit can then be arranged and positioned for transporting material away from the inlet of the processing unit. This allows a regulation of the amount of material that is fed into the inlet of the processing unit and therefore partly determines the filling level in between the holding members.

It should be noted that the filling unit could be used with other types of processing units as well. The first and second holding members are preferably connected to the inlet and outlet of the processing unit. Consequently, material fed into the processing unit will directly be in between the first and second holding member. Additionally, more holding members could be provided to obtain a clamping in more directions.

In a preferred embodiment, the first holding member comprises a first holding plate and the second holding member comprises a second holding plate. These holding plates are disposed to form a compression channel for the material. Material fed into the processing unit must move through this channel where it is subjected to the compression and expansion movement of at least one of the first and second plate.

It is convenient if the first holding plate comprises openings adapted to receive impurities released from the material. During motion of the first holding plate impurities released from the material can removed through the opening(s) in the first holding plate. By arranging the first holding plate below the second holding plate, this removal can be assisted by a gravitational force.

If the openings in the first plate are elongated in a direction of propagation of the material through the compression channel, the material is not likely to get caught in the openings thereby obstructing the stream of material.

More of these plates can be placed in series, wherein each plate is provided with openings having a different type or size, and wherein the plates with the larger openings are put into contact with the material first. This allows for a finer sieving of the impurities without the risk of the impurities blocking the openings. In a preferred embodiment, the device, or more in particular the impurities collection unit or the processing unit, comprises at least one sieve plate having openings therein adapted to receive impurities released from the material. The openings of the first holding plate are larger in at least one direction than the openings in the at least one sieve plate. Furthermore, the at least one sieve plate is arranged in between the first holding plate and the impurities collection unit. Impurities released from the material must therefore pass through the first holding plate and the added sieve plate, thereby obtaining a finer sieving. If the first holding member comprises only a single plate and/or if the holding member does not comprise sieve components that during use can trap impurities released from the material between them, small particles can be filtered out. Should impurities get trapped in between moving parts, these parts could get damaged. The first holding member could comprise only a single first plate that acts as a sieve, although more sieves can be placed in series.

A preferred embodiment of the impurities collection unit comprises an impurities container and means for generating an air flow. The air flow is adapted to transport impurities released from the material to the impurities container. The air flow generating means could for instance comprise a vacuum pump or an air blower.

The compression and expansion movement could be realized if the drive unit is arranged to cause a relative repeated shaking motion between the first holding member and the second holding member.

A simple configuration of the device can be obtained if the tooth plate of the first comb unit and first holding plate are fixedly connected to form a connected plate. In this case, the movement of the tooth plate is transferred to the first holding plate. For instance, if the movement of the tooth plate is circular, the movement of the first plate will be too. A single mechanical drive can therefore be used to loosen the material, e.g. from a bale, and to subject the material to the compression and expansion movement. An example of such a single drive is a mechanical drive having a first crank coupled thereto. This crank in turn is coupled to the connected plate. The rotational movement of the shaft of the engine will be transformed to a circular movement by the first crank. The connected plate, i.e. the tooth plate and first holding plate fixedly connected, can be coupled to the first crank by a first connecting rod. This connecting rod is hingedly connected to the first crank and fixedly connected to the connected plate. Additionally, the connected plate can be hingedly connected to a stationary mounting frame by a first swinging arm. This swinging arm has one end thereof hingedly connected to the mounting frame and another arm thereof hingedly connected to the connected plate.

Similarly, the tooth plate of the second comb unit is preferably coupled to a second crank, wherein the second crank is coupled to a mechanical drive to drive the tooth plate of the second comb unit. As with the connected plate, the tooth plate of the second comb unit can be coupled to the second crank by a second connecting rod. The second connecting rod is hingedly connected to the second crank and fixedly connected to the tooth plate of the second comb unit. Additionally, the tooth plate of the second comb unit can be hingedly connected to a stationary mounting frame by a second swinging arm. This swinging arm has one end thereof hingedly connected to the mounting frame and another arm thereof hingedly connected to the tooth plate of the second comb unit. It should be noted that the above mentioned mounting frame is preferably the same mounting frame as that for the mounting of the first swinging arm.

The mechanical drive for driving the connected plate is preferably also arranged to drive the tooth plate of the second comb unit. In that case, it is advantageous if the mechanical drive is coupled to a shaft, which is coupled to the first and second crank. It is convenient if there is a mechanical offset between the first and second unit such that a protruded position of the first corresponds to a retracted of the latter, and vice versa. An objective of the present invention can also be obtained by a method as described in claim 29. According to the present invention, the method comprises providing a first and second holding member defining a holding space there between for holding said material, filling the material in between the first and second holding member to obtain a filling of the material, moving the first holding member relative to the second holding member to obtain a compression and of the holding space, and collecting impurities released from the material. The filling of the material extends from the first holding member to the second holding member.

Preferably, the method also comprises loosening of the material prior to the filling with the material. The filling and the moving of the first holding member can be performed automatically.

To obtain a stream of material, the method could comprise propagating the material in between the first and second holding member. To ensure a filling of material that extends from the first holding member to the second holding member, the method could comprise the synchronization of the filling and propagating.

In the following, embodiments of the present invention will be described in more detail under reference to the accompanied drawings in which:

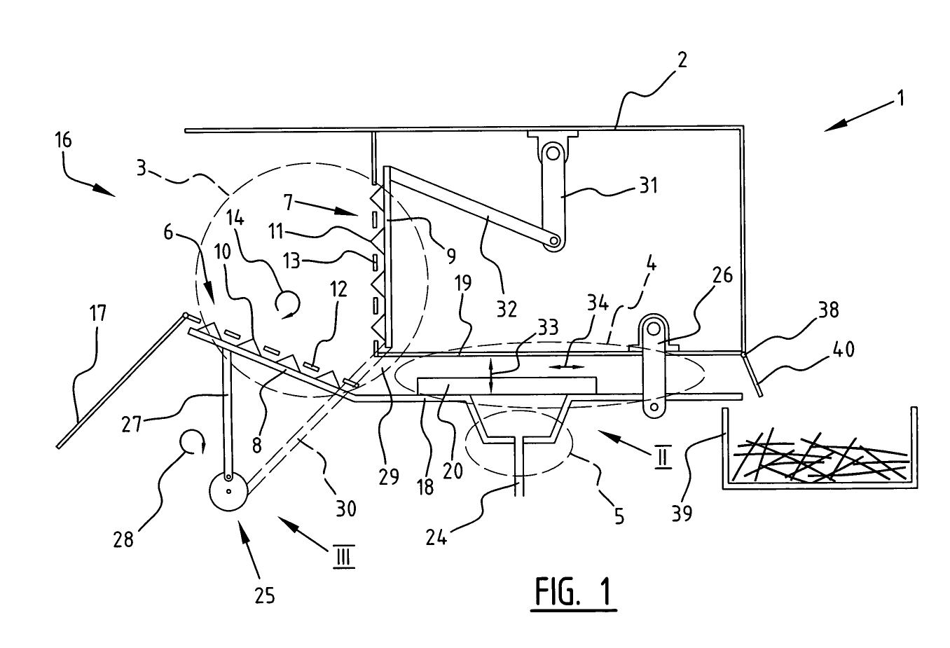

FIG. 1 shows a preferred embodiment of the present invention;

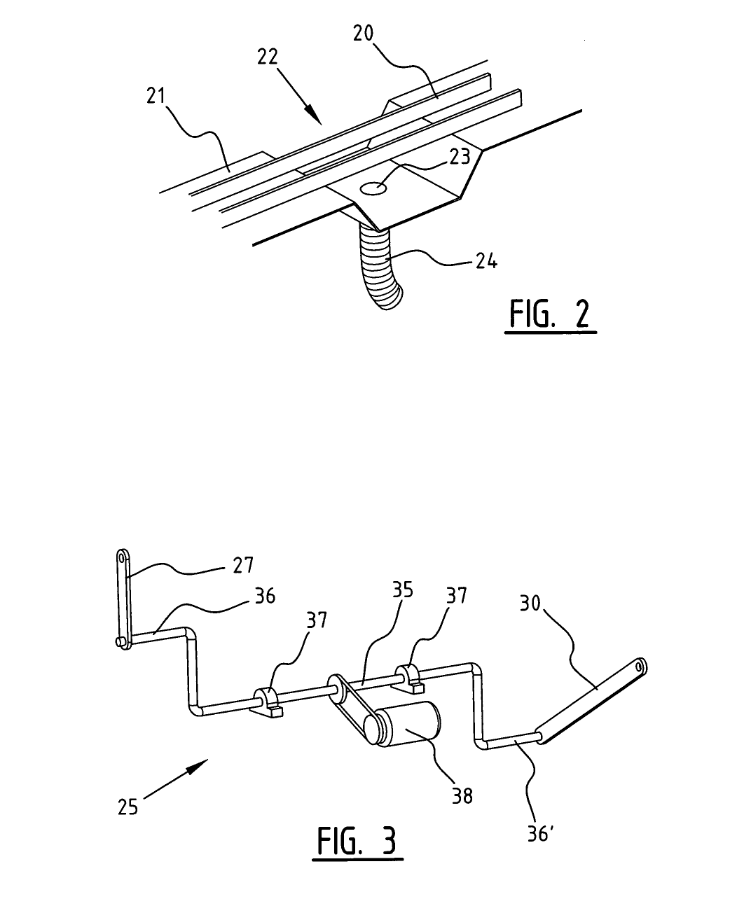

FIG. 2 illustrates a perspective view of the first holding member of the device in FIG. 1;

FIG. 3 shows a schematic perspective view of a crank connected to two connection rods of the device in FIG. 1.

FIG. 1 illustrates an embodiment of the device 1 according to the invention. The device comprises a mounting frame 2 to which the various components of the device are mounted. Mounting frame 2 is preferably stationary during operation. However, it is convenient if device 1 is mobile such that the device can for instance be moved in and out off stables.

Device 1 can be subdivided in three parts: a filling unit 3, a processing unit 4, and an impurities collection unit 5. Filling unit 3 comprises a first comb unit 6 and a second comb unit 7. Each unit comprises a tooth plate 8, 9 provided with toothed structures 10, 11. Tooth plates 8, 9 are arranged behind release plates 12, 13. These plates are provided with openings through which the toothed structures can protrude and retract. During operation, the toothed structures describe a motion as illustrated by arrows 14, 15.

Agricultural fibrous material, such as straw and or hay, can be fed to device 1 through inlet 16. In FIG. 1, a lid 17 is illustrated with which device 1 can be opened. The inlet can be provided with known means to facilitate the loading of device 1.

Processing unit 4 comprises a first 18 and second 19 holding member defining a holding space, in other words a compression channel, there between for holding the material. Processing unit 4 is connected to impurities collecting unit 5. Second holding member 19 is connected to or part of mounting frame 2. First holding member 18 comprises a set of spaced apart bars 20 that extend in the direction of propagation of the material, see FIG. 2. Together, bars 20 form a first plate provided with elongated openings. In addition, bars 20 are mounted to a further plate 21 that has an opening 22. Impurities released from the material can fall through the elongated openings in between the bars and through opening 22. As such, further plate 21 and bars 20 function as a sieve. An outlet 23 is provided with which the impurities can be removed from opening 22. In a preferred embodiment, outlet 23 is connected to a vacuum pump through a flexible tube 24. A filter system (not shown) can be used to make sure that impurities are not reaching the vacuum pump itself.

The elongated openings in between the bars should be such that not only small particles, such as animate matter, can fall through, but also larger particles, such as inanimate matter. As such, the smallest dimension of the opening should preferably be at least 0.1 mm. The skilled person should understand that various other sieve like arrangements can be used that provide a similar effect, for instance a series connection of sieves that have various types and sizes of openings.

First plate 20 is fixedly connected to tooth plate 8 forming one connected plate. This connected plate is in turn at one end coupled to a mechanically driven crank 25 (schematically illustrated), and at another end to a swinging arm 26. Swinging arm 26 has one end thereof hingedly mounted to mounting frame 2, and other end thereof hingedly connected to the connected plate. The connection between the connected plate and crank 25 is achieved using a connection rod 27. This rod is at one end hingedly connected to crank 25 and at another end fixedly connected to the connected plate.

During use, the connection point between connection rod 27 and crank 25 describes a circular motion as shown by arrow 28. This motion is transferred to the connected plate.

Consequently, toothed structures protrude through the openings in release plate 12, engage the material, and transport the material towards processing unit 4. Upon retraction through the openings in release plate 12, material is released by the interaction with release plate 12. In a subsequent protrusion, toothed structures 10 once again engage the material to loosen it, e.g. from a bale, and transport it even further to processing unit 4.

The circular motion is also transferred to first holding member 18. Consequently, a relative compression and expansion movement is induced between the first 18 and second 19 holding member, thereby obtaining a compression and expansion of the compression channel. This motion is a repeated motion. The compression and expansion is related to the vertical direction as indicated by arrow 33. In addition, a shaking motion is induced as indicated by arrow 34. These different types of movement occur simultaneously. It should be obvious to the skilled person that modifications to this motion can be realized by changing the connection to the swinging arm 26 and crank 25.

Due to the movement towards inlet 29 of processing unit 4 induced by toothed structures 10, material is pushed through inlet 29. As such, first comb unit 6 not only loosens material but it also transports material towards inlet 29 and through the compression channel formed by the first 18 and second 19 holding members.

The optimal effect of the relative compression and expansion movement of the first 18 and second 19 holding members, or in other words the compression and expansion of the compression channel, can be achieved when the filling of the material extends from the first 18 to the second 19 holding member. Especially in this situation, the elastic deformation of the fibers results in an effective removal of impurities from the fibers.

It should be noted that the above mentioned filling can be obtained by controlling the speed of comb units 8, 9. In addition, also the shape and size of the toothed structures 10, 11 are important because those factors determine how much material is loosened from a bale during a protrusion movement.

Second comb unit 7 is connected to crank 25 in a similar fashion. Consequently, toothed structures 11 will describe a similar motion as toothed structures 10. However, the function of second comb unit 7 is different from that of the first comb unit 6. Second comb unit 7 removes excess material at the inlet 29 of the processing unit to avoid blocking thereof. Material is engaged by the toothed structures 11, moved upwards in FIG. 1, and released by engaging with release plate 13. Material will then fall back onto first comb unit 6. Tooth plate 9 has end thereof connected to crank 25 by means of a connection rod 30, and another end thereof to a swinging arm 31 by means of a further connection rod 32. Connection rod 32 is fixedly connected to tooth plate 9 and hingedly connected to swinging arm 31. Connection rod 30 is fixedly connected to tooth plate 9 and hingedly connected to crank 25. Swinging arm 31 is at one end thereof hingedly connected to mounting frame 2 and at another end thereof hingedly connected to connection rod 32.

FIG. 3 illustrates a schematic perspective view of crank 25 and connection rods 27, 30. Crank 25 comprises a central portion 35 and two eccentric portions 36, 36′ to which connection rods 27, 30 are connected, respectively. Crank 25 is rotationally mounted to mounting frame 2 using bearings 37. Central portion 35 is driven by a mechanical drive 38 (schematically illustrated) using known transmission techniques, e.g. a belt or chain.

As illustrated in FIG. 3, eccentric portions 36, 36′ are arranged at an offset from each other. In other words, when eccentric portion 36 is pointing upwards, portion 36′ is pointing downwards and vice versa. As a result, whenever toothed structures 10 are in a fully protruded position, toothed structures 11 are in a fully retracted position, and vice versa. This offset can be altered by changing the relative orientation of eccentric portions 36, 36′. At the outlet 38 of device 1, material exits the compression channel to be collected in a container 39. A resiliently mounted lid 40 is provided to keep enough filling at the end of the compression channel to avoid a more or less direct connection between the ambient air and the vacuum pump which would result in loss of suction power.

Because during the different stages of handling the material impurities may be removed from the fibers, device 1 is preferably completely sealed. During use, inlet 16 closes off filling unit 3 so that impurities are kept inside.

In the description above, embodiments of the invention have been described. It should be obvious to the skilled person in the art that various modifications are possible without deviating from the scope of the invention as defined by the appended claims.

For instance, a spray unit can be incorporated into device 1, to spray liquids or other substances onto the material to either add nutritional value to the material or to provide an anti-bacterial and/or anti-fungal effect. Such a spray unit could be placed in the filling unit and or the compression channel.

The loosening means could additionally or alternatively be placed in the processing unit. For example, the toothed structures could be mounted to the second holding member in the compression channel. In this configuration, material can still be compressed and expanded, while at the same time, the material is loosened. Toothed structures arranged in the processing unit could also provide transport functionality. The loosening means could also comprise multiple tooth plates that move relative to each other. In this arrangement, multiple tooth plates, elongated in the propagation direction of the material, are aligned next to each other. Every other elongated plate is mechanically coupled such that two groups of coupled plates exist. Each group is mechanically driven by a separate crank such as discussed above. As a result, a tooth plate that is in an upward position is surrounded by tooth plates that are in a downward position. Using this arrangement, material can be loosened and transported without the use of release plates. Material that is gripped by the upper tooth plate will be released by a neighboring tooth plate when the latter moves upward and the former moves downward.

An important aspect of the invention is the compression and expansion movement of the holding members, wherein material is held and or clamped between them. This arrangement is not restricted to compression movement perpendicular to the movement of the material in between the holding members. For instance, the toothed structures could be used to loosen the material, transport it towards the outlet of the device, and to provide the compression and expansion movement. This latter movement is related to the pushing effect that the toothed structures have on the material. In this arrangement, the compression is the direction parallel to the movement of the material. It is therefore possible to combine the filling unit and processing unit into a single unit. It should be noted that in this case the loosening of material and the subjection of this material to compression and expansion movement occurs simultaneously.

Several toothed structures can be placed in series to obtain a more gradual loosening of the material. First large pieces should be loosened, which in a later stage are loosened into even finer pieces.

The openings in the holding members can be arranged in the first and or second holding member. For instance, when the openings are provided in the second holding member in FIG. 1, the sieve function is thereby obtained using a stationary member. It is therefore not necessary to have a moving sieve. Important is that impurities are removed from the material due to the relative compression and expansion movement of the holding members.

1. A device for removing impurities from an agricultural fibrous material, such as straw or hay, comprising:
a processing unit having an inlet, an outlet, and a first and second holding member defining a holding space there between for holding said material, wherein at least said first holding member is moveable;
a drive unit for driving at least said first moveable holding member to obtain a compression and expansion of said holding space;
an impurities collection unit coupled to or disposed in said processing unit to collect impurities released from said material.

2. The device according to claim 1, further comprising a filling unit arranged for filling said processing unit with said material through said inlet to obtain a filling of said material, wherein said filling unit is capable to obtain a filling of said material extending from said first holding member to said second holding member.

3. The device according to claim 2, further comprising a transport unit for obtaining a stream of said material from said inlet to said outlet of said processing unit.

4. The device according to claim 3, further comprising a controller for controlling said transport unit and said filling unit to achieve said filling of said material extending from said first holding member to said second holding member.

5. The device according to claim 4, wherein said transport unit and said filling unit are arranged to generate a continuous stream of said material.

6. The device according to any of the claims 2-5, wherein said filling unit is provided with an inlet and an outlet, wherein said inlet of said filling unit is adapted to receive a bale of said material and said outlet of said filling unit is coupled to said inlet of said processing unit.

7. The device according to any of the claims 2-6, wherein said filling unit comprises means to loosen said material.

8. The device according to claim 7, wherein said loosening means comprise a first comb unit, said first comb unit comprising:
a release plate provided with an opening;
a toothed structure adapted to protrude and retract through said opening;
a mechanical drive for driving at least one of said toothed structure and release plate to obtain a protrusion and retraction movement of said toothed structure through said opening;
wherein in a protruded position said toothed structure is arranged to engage said material and wherein in a retracted position said release plate is adapted to release said material from said retracted toothed structure.

9. The device according to claim 8, wherein said toothed structure is arranged on a tooth plate, and wherein said mechanical drive is arranged to drive said plate.

10. The device according to claim 8 or 9, wherein said toothed structure and mechanical drive are arranged to transport said material parallel to said release plate.

11. The device according to any of the claims 8-10, wherein said opening in said release plate is elongated along a first direction, and wherein during use said mechanical drive induces a turning motion to said toothed structure, said turning motion having a turning axis being perpendicular to said first direction.

12. The device according to any of the claims 8-11, wherein said filling unit comprises a second comb unit, said first comb unit arranged and positioned to loosen said material and to transport said material towards said inlet of said processing unit and wherein said second comb unit is arranged and positioned for transporting material away from said inlet.

13. The device according to any of the claims 1-12, wherein said inlet and said outlet of said processing unit are connected to said first and second holding member.

14. The device according to any of the claims 1-13, wherein said first holding member comprises a first holding plate and said second holding member comprises a second holding plate, said first and second holding plate disposed to form a compression channel for said material.

15. The device according to claim 14, wherein said first holding plate comprises openings adapted to receive impurities released from said material.

16. The device according to claim 15, wherein said openings in said first holding plate are elongated in a direction of propagation of said material through said compression channel.

17. The device according to claim 15 or 16, comprising at least one sieve plate having openings therein adapted to receive impurities released from said material, wherein the openings of the first holding plate are larger in at least one direction than the openings in said at least one sieve plate, and wherein said at least one sieve plate is arranged in between said first holding plate and said impurities collection unit.

18. The device according to any of the claims 1-17, wherein said impurities collection unit comprises:
an impurities container;
means for generating an air flow, said air flow adapted to transport impurities released from said material to said impurities container.

19. The device according to claim 18, wherein said air flow generating means comprise a vacuum pump.

20. The device according to any of the claims 1-19, wherein said drive unit is arranged to cause a relative repeated shaking motion between said first holding member and said second holding member.

21. The device according to claim 20 in so far as depending on claim 9, wherein said tooth plate of said first comb unit and said first holding plate are fixedly connected to form a connected plate.

22. The device according to claim 21, wherein said connected plate is coupled to a first crank, said first crank being coupled to a mechanical drive to drive said connected plate.

23. The device according to claim 22, wherein said connected plate is coupled to said first crank by a first connecting rod, said first connecting rod being hingedly connected to said first crank and fixedly connected to said connected plate.

24. The device according to claim 23, wherein said connected plate is hingedly connected to a stationary mounting frame by a first swinging arm, said first swinging arm having one end thereof hingedly connected to the mounting frame, and another arm thereof hingedly connected to said connected plate.

25. The device according to any of the claims 12-24 in so far as depending on claim 9, wherein the tooth plate of said second comb unit is coupled to a second crank, said second crank coupled to a mechanical drive to drive said tooth plate of said second comb unit.

26. The device according to claim 25, wherein said tooth plate of said second comb unit is coupled to said second crank by a second connecting rod, said second connecting rod being hingedly connected to said second crank and fixedly connected to said tooth plate of said second comb unit.

27. The device according to claim 26, wherein said tooth plate of said second comb unit is hingedly connected to a stationary mounting frame by a swinging arm, said swinging arm having one end thereof hingedly connected to the mounting frame, and another arm thereof hingedly connected to said tooth plate of said second comb unit.

28. The device according to any of the claims 22-27 in so far as depending on claim 25, wherein said mechanical drive for driving said connected plate is also arranged to drive said tooth plate of said second comb unit.

29. The device according to claim 28, wherein said mechanical drive for driving said connected plate and said tooth plate of said second comb unit is coupled to a shaft, said shaft being coupled to said first and second crank.

30. A method for removing impurities from an agricultural fibrous material, such as straw or hay, comprising:
providing a first and second holding member defining a holding space there between for holding said material;
filling said material in between said first and second holding member to obtain a filling of said material;
moving said first holding member relative to said second holding member to obtain a compression and expansion of said holding space;
collecting impurities released from said material;
wherein said filling extends from said first holding member to said second holding member.

31. The method according to claim 30, further comprising loosening said material prior to said filling with said material.

32. The method according to claim 30 or 31, wherein said filling and said moving is performed automatically.

33. The method according to any of the claims 30-32, further comprising propagating said material in between said first and second holding member.

34. The method according to claim 33, further comprising synchronizing said filling and said propagating to obtain said filling of said material.
